(19) United States
(12) Patent Application Publication
(10) Pub. No.: US 2002/0154745 A1
(43) Pub. Date: Oct. 24, 2002

(54) Systems and methods for visual access to voicemail

(76) Inventor: Yuri Shtivelman, San Francisco, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/841,737

(22) Filed: Apr. 24, 2001

(51) Int. Cl. H04M 1/64; H04M 1/56

(52) U.S. Cl. 379/88.12; 379/142.17

(57) ABSTRACT

Systems and methods for providing visual information to a telephone user regarding multiple voicemail services associated with the telephone user. The method includes providing a telephone comprising a display and organizing information relating to messages in the voicemail, wherein the information comprises an identifier indicating with which voicemail service each message is associated. Finally, the information is displayed on the display. Additional information may include the number of messages, a primary phone number from which each message was received, a name associated with each primary phone number, at least one alternative phone number associated with each primary phone number and a length of time for each message.

### BACKGROUND OF THE INVENTION

1. Field of the Invention

The present invention relates to access to voicemail and telephone systems, and more particularly, to a visual access to voicemail systems in wireless telephones.

2. Description of the Prior Art

In modern telephone systems, the voicemail feature is a great convenience and help to users. Users may have the telephone voicemail as a feature of the public carrier supplying their home phone system, as a feature of their office PBX, or as part of their mobile phone system. Voicemail is particularly important in mobile phone systems since, users often, even while carrying the telephone, may not be able to receive calls because of bad reception due to the topology of an area, network overload, interference with any building, and many other possible causes.

In today's society, immediate telephone communication has become important to most telephone users. This is particularly true with respect to mobile telephone users whose phone calls may not always get through. Additionally, mobile telephone users, as indicated by the very fact of subscribing to a mobile phone service, attach great importance to always being in contact by telephone. Thus, it is important to many users that they know as soon as possible whether, and from whom, they have received voicemail.

Unfortunately, today's telephone voicemail systems typically supply limited information about received voicemail messages. Today's voicemail systems typically, if one is lucky, merely indicate the number of messages contained therein. People are generally busy with business matters, family matters, and/or school matters, etc. Accordingly, people are generally juggling many activities at once and are generally attempting to communicate with numerous other people. It is often difficult to reach these other people for the same reasons—they are likewise busy with various matters. Therefore, people often need to leave messages on voicemail systems and obviously, certain matters are more urgent than others so that people often need to speak more urgently with certain people. Accordingly, current voicemail systems make it difficult for telephone users to make informed decisions about which voicemails have the highest priority for listening and responding thereto.

Furthermore, many people have more than one voicemail service due to having multiple phone numbers. For example, a user may have, besides the voicemail for the cell phone, additional voicemail service for home or office, or even multiple additional services.

Thus, it would also be helpful to telephone users to aggregate one visual listing of messages out of all the user's various voicemail services, so the user can in one glance see a listing of all the voicemail messages and decide how to prioritize all of them.

### SUMMARY OF THE INVENTION

The present invention provides novel systems and methods for providing visual information to a telephone user regarding voicemail associated with a telephone number. The method includes providing a telephone comprising a display and organizing information relating to messages in the voicemail, wherein the information comprises an identifier indicating with which voicemail service each message is associated. Finally, the information is displayed on the display.

In accordance with one aspect of the present invention, the information further comprises at least one of the number of messages, a primary phone number from which each message was received, a name associated with each primary phone number, at least one alternative phone number associated with each primary phone number and a length of time for each message.

In accordance with a further aspect of the present invention, at least some of the information is provided by one of caller identification (CALLER-ID), ANI or voice prompt and complemented from a lookup directory.

In accordance with yet another aspect of the present invention, the lookup directory is contained on a voicemail server.

In accordance with a further aspect of the present invention, the lookup directory is contained on a wireless application protocol server.

In accordance with another aspect of the present invention, the lookup directory is contained on the telephone.

In accordance with yet a further aspect of the present invention, the method further includes selecting a message to which to listen based upon the information.

In accordance with yet another aspect of the present invention, the method includes returning a phone call based upon the information.

In accordance with a further aspect of the present invention, the phone calls returned by pressing a single button on the telephone.

In accordance with yet another aspect of the present invention, the method further comprises aggregating messages from the at least two voicemail systems onto one of the at least two voicemail systems.

In accordance with a further aspect of the present invention, the messages from the at least two voicemail systems are maintained on their respective voicemail systems.

The present invention also provides a system for providing visual information to a telephone user regarding voicemail and a telephone number. The system includes a telephone network, a telephone comprising a display and that is in communication with the telephone network, a voicemail system and a visual voicemail manager. The visual voicemail manager is configured to organize information relating to messages in the voicemail system wherein the information comprises an identifier indicating with which voicemail service each message is associated. The visual voicemail manager is also configured to display the information on the display.

Thus, the present invention provides systems and methods for providing visual access to multiple voicemail systems, thus allowing the user to prioritize which message(s) to listen to and/or respond to based upon information provided by the visual voicemail system. The user is able to prioritize their messages from various voicemail systems such as, for example, a cell phone, a home phone and a business phone. The user may not only review the status of their messages, but may also save time and effort associated with listening to each message in a long list of messages in search of a particularly important message for which they have been waiting.

Other features and advantages of the present invention will be understood upon reading and understanding the detailed description of the preferred exemplary embodiments, found hereinbelow in conjunction with reference to the drawings in which like numerals represent like elements.

### BRIEF DESCRIPTION OF THE DRAWINGS

FIG. 1 is a schematic illustration of a voicemail system in accordance with one embodiment of the present invention;

FIG. 2a is an elevational view of an example of a display for a telephone;

FIG. 2b is an elevational view of an example of a display for a telephone in accordance with the present invention;

FIG. 3 is a schematic illustration of a voicemail system in accordance with a further embodiment of the present invention; and

FIG. 4 is an elevational view of an example of a display for a telephone in accordance with the embodiment of the present invention illustrated in FIG. 3.

### DETAILED DESCRIPTION OF PREFERRED EXEMPLARY EMBODIMENTS

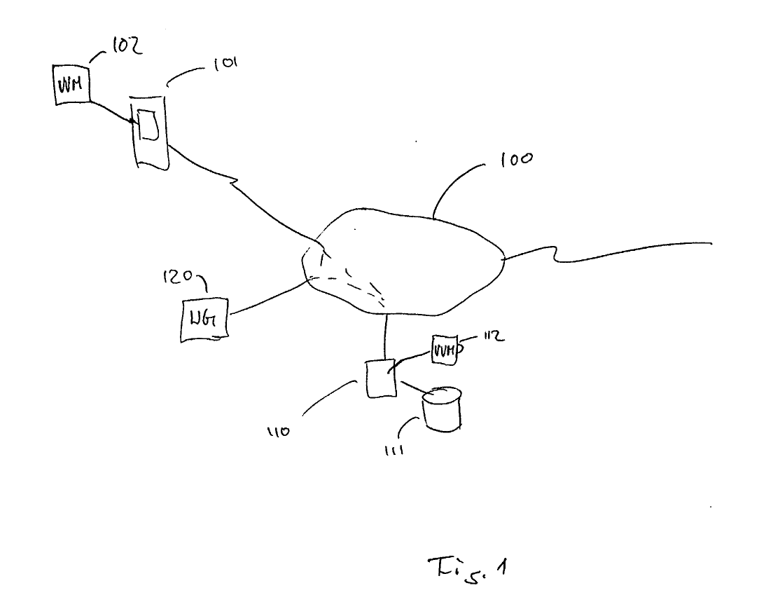

FIG. 1 schematically illustrates an embodiment of the present invention, specifically, topology for a wireless phone system 100 (network cloud) with a wireless application protocol (WAP) phone 101 connected thereto and a special voicemail software instance visual voicemail (VVM) 102. Also shown is a WAP gateway 120 that in some cases may be necessary for the present invention and in other cases may not, and a voicemail server 110 with attached mass storage 111 containing the voicemails.

Those skilled in the art will understand that WAP is not a requirement, but instead merely a convenience, to implement the present invention. Other standards known, or yet to be defined, such as micro browsers or even proprietary architectures, may be used to achieve the same. Other technologies may have a different portioning between the client and the server. In some cases, the client hardware may be merely a terminal, and the application VVM 102, as described above, may run exclusively on the server, somewhere in the network. Whereas in other cases, just the opposite may happen, and no auxiliary server, as described above (server WAP gateway 120) may be required.

Special voicemail software instance 102 is a visual voicemail (VVM) manager that is compatible with any of the numerous voicemail systems currently known in the art. While typically it may reside in mobile handset 101, a WAP phone in this example, in other cases, however, VVM 102 may be loaded on demand from a server, using a shortcut or other link, as allowed by current telephone system technology and able to be implemented by one skilled in the art. The VVM 102 has two-way communication capabilities, with either the VM server 110 directly, or in some cases via WAP gateway 120, as described herein below.

Depending upon the architecture of the software and the telephone system, the WAP gateway 120 may be a required element for the phone 101 to connect to the server 110. In other cases, for example, a proprietary network, such a gateway may not be required.

Also, within voicemail server 110 there is preferably, in addition to the software normally residing in such a server, a visual voicemail presenter (VVMP) software instance 112.

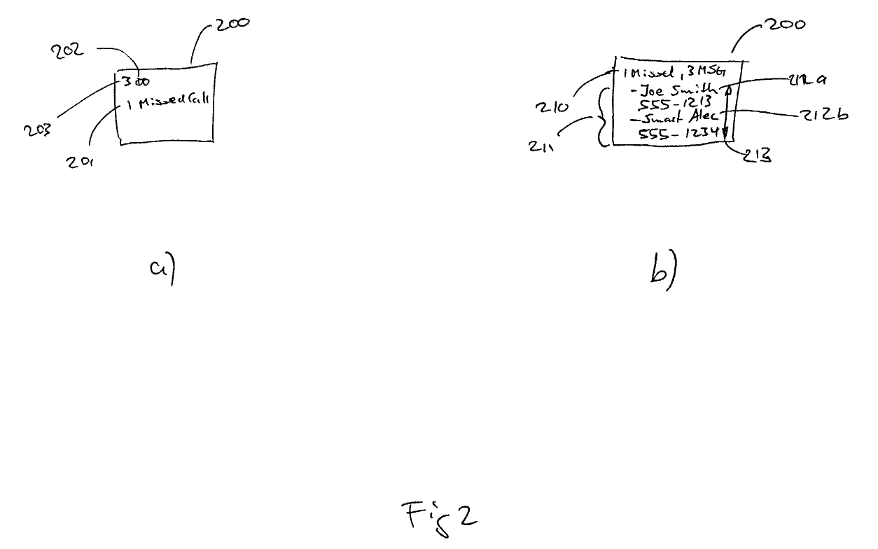

FIG. 2a illustrates a screen, for example a liquid crystal display (LCD), as is typically available on mobile and other types of phones today. Screen 200 displays a message 201 showing, for example, one missed call (i.e., a call that the telephone receives but the user does not answer, as differentiated from a call that the telephone cannot receive, as discussed in the background section of this disclosure). Screen 200 also contains indicator 202 showing the presence of voicemail. In some cases a numeric count 203 may show the number of voicemail messages currently stored. However, these messages and indicators do not make it possible for the user to know who left the voicemails, the telephone numbers of callers, the length of the messages, or any other particulars of each message. Hence it is impossible for the user to prioritize responses without first listening to all the messages.

FIG. 2b illustrates a display as presented by the VVM 102 on a phone screen 200. Header line 210 illustrates a message status summary of, for example, one missed call and three voicemail messages. A list 211 comprises all the entries, each entry representing one voicemail message. The list 211 may be scrolled using scroll bar 213. Each entry, such as 212a, 212b, etc., may contain information such as a telephone number of the caller, derived either by caller-ID, ANI, or voice prompt and complemented from a lookup directory (not shown) that may be on either the voicemail server 110 or the WAP gateway 120, the telephone itself, or any other server. The information may also include the caller's name (which may be a person or organization, for example) and other optional information such as at least one alternate phone number for the caller (or at least one alternate phone number associated with the first telephone number), the length of the message (for example, a very short message may be unusable or insignificant), and other pertinent information about each voicemail message. In some cases this information may also be extracted from a PDA database that may reside on the WAP phone (not shown).

By viewing the list of messages 211, the user may now decide which message to respond to first, select that message, and, for example, play the message by pressing a button while highlighting the title of the message, or may initiate a return phone call by pressing a button on the telephone while highlighting the caller's phone number. It is an important aspect of the present invention that the user may not only view the status of messages, but may also save the time and effort of listening to each message in a long list of messages, in search of a particularly important message for which he's been waiting. It is also an important aspect of the present invention that the VVM 102, due its interactive nature, may have numerous additional features, including but not limited to, for example, permitting a user to delete a voicemail unheard, copying or forwarding a message to other people, managing lists or groups for distribution of messages, etc.

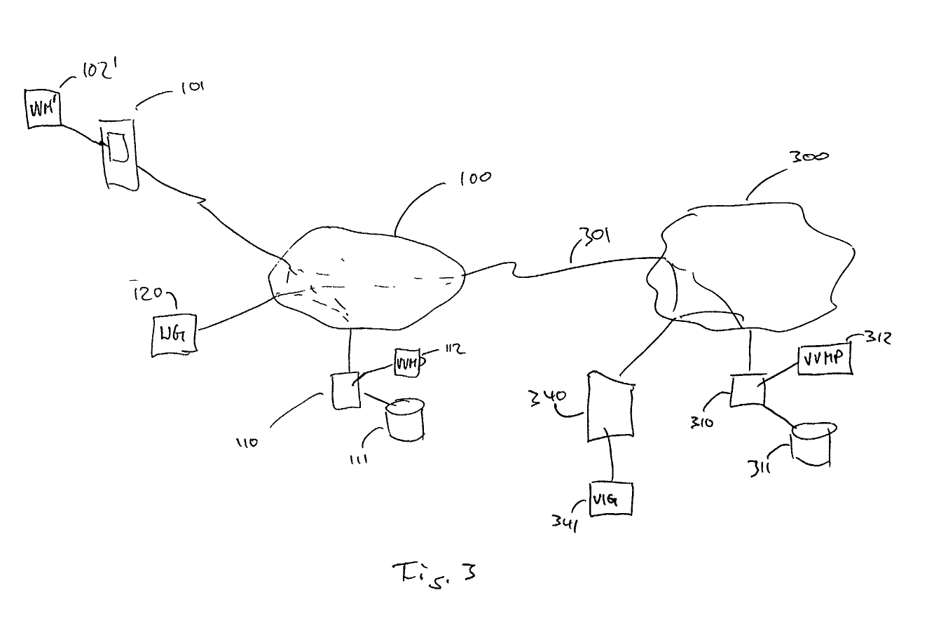

FIG. 3 shows a system similar to the system shown in FIG. 1, but with additional elements. In this embodiment, a user of WAP phone 101 has, in addition to his cell phone voicemail system on voicemail server 110, as described above, an additional voicemail system on a voicemail server 310. Such an additional voicemail system may serve, for example, the user's home or office. Voicemail server 310 preferably includes a mass storage unit 311, similar to unit 111 coupled to voicemail server 110 in FIG. 1. In some instances, server 310 may include a VVMP module 312. Such additional systems are generally situated on a WAN, which may be a public service telephone network (PSTN), the Internet, or other similar public or private WANs. A method of linking to wireless service provider network 100 is illustrated as a simple line 301, and depending on the type of network, some translation, etc., may be involved (not shown). Those skilled in the art will understand that such translation is not pertinent to the present invention.

In instances where the voicemail system service that manages server 310 does not cooperate with the service providing the VVMP, and hence VVMP 312 cannot be installed on the voicemail server 310, a proxy server 340 or gateway may be inserted in the communication path between server 310 and the phone system 100 to allow access to the voicemail messages on server 310. In such cases, a gateway 340 may be, for example, a modified voice response unit (VRU) containing a special visual interface gateway (VIG) application 341 that may access the voicemail server 310 by dialing through the VRU menus of server 310 (for example, Pacific Bell home voicemail with remote access) by generating DTMF commands. The VRU 340 may then extract the information presented by voicemail 310 and transmit the results in the form of a data record, via either WAP gateway 120 or directly to WAP phone 101.

As a result, the enhanced application VVM', which is software instance 102′, may now display not only all the messages from multiple voicemail systems, but may also indicate from which voicemail system each message came.

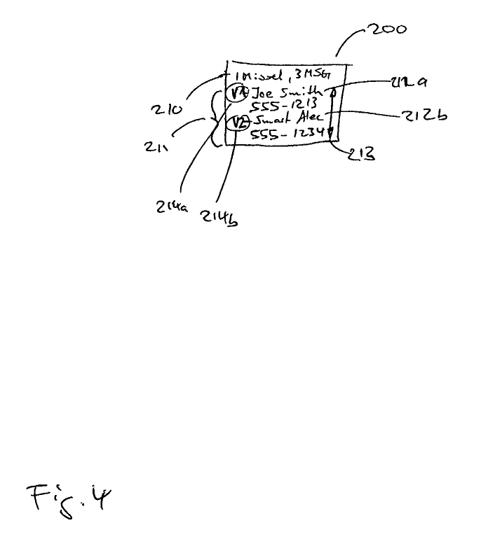

FIG. 4 illustrates such a display of such an enhanced system, where in addition to the elements described above in the description of FIG. 2b, new elements 214a and 214b are introduced, illustrating, for example, V1 and V2, abbreviations indicating voicemail system 1 and voicemail system 2. It is clear that icons or other descriptive labels may be used for the purpose of visually differentiating one voicemail system from another within list 211, in place of V1 and V2, and that any system of unique identifiers is within the scope of the present invention.

Also, in some cases, a complete entry may consist of an identifier such as an icon or other label, rather than textual entries, etc. For example, a user may be able to assign certain icons to certain frequent callers, so that the user may then recognize the identity of a caller without all the text or other characters of the name of that caller occupying space in the list. Similarly, other information about a frequent caller, such as the telephone number, may be represented by a previously defined icon or abbreviation to reduce the total space (number of lines) in the list and to make scrolling through the list go more quickly.

Another feature to let a user more easily manage the list contents is a hierarchical sort function, so that the user could sort the list by caller, date, etc. Such a feature may be included with the system if desired

In some cases, the handset plays a role of a visual (or “virtual”) voice-mail aggregator, without a “real,” physical voice-mail aggregation taking place, meaning the voice files themselves are still stored at the (one or more) VM server(s). In other cases, aggregation takes place in real time, while the phone is checking a voice mail system. It is clear that this approach means extra time to connect to the second (third, etc.) voice mail system, and it is hence subject to connection conditions. Also, in a case of interrupted connection, the aggregation may only be partial or virtual, as discussed earlier. In the cases of the alternatives based on the “real” aggregation, visual presentation of aggregated voicemails may still be the one proposed earlier, but messages may be aggregated physically either on a server (such as WAP gateway 120, or any other server), or on a client. The server in some cases may be one of the voice-mail servers augmented with the aggregation functionality, or a separate “aggregator” server (not shown). The client may be a handset itself (requiring beefed up memory).

In some cases both features (server-based aggregation and client-side aggregation/presentation) may be used simultaneously: voice mail may be aggregated on a server and then downloaded to the handset (or PDA, or any wireless, or even wireline connected device). In yet other cases, keeping or deleting voicemails on the original server after aggregation/download is done, etc.

One advantage of a server-based aggregation is that because it is done offline, it minimizes call time. On the other hand, an advantage of a client-based aggregation is that after download you may play voicemails at your leisure, even when not in a networking area, and even record responses to send later (for example, when network conditions improve).

In some cases the aggregation may be done on the server, however copied to the client, so it may be available even if the connection is no longer available.

The present invention is ideally suited for mobile telephone service providers as well as traditional telephone service providers for selling to their clients as an additional service. It may be provided over any of analog, digital and data network telephony.

Although the present invention has been described with reference to specific exemplary embodiments, it will be appreciated that it is intended to cover all modifications and equivalents within the scope of the appended claims.

What is claimed is:

1. A method of providing visual information to a telephone user regarding voicemail associated with the telephone user, the method comprising:
a. providing a telephone comprising a display;
b. organizing information relating to messages in at least two voicemail services, the information comprising an identifier indicating with which voicemail service each message is associated; and
c. displaying the information on the display.

2. The method of claim 1 wherein the information further comprises at least one of the number of messages, a primary phone number from which each message was received and a name associated with each primary phone number.

3. The method of claim 2 wherein the information further comprises at least one of at least one alternative phone number associated with each primary phone number and a length of time for each message.

4. The method of claim 2 wherein at least some of the information is provided by one of caller identification (caller-ID), ANI or voice prompt and complemented from a look-up directory.

5. The method of claim 4 wherein the look-up directory is contained on a voicemail server.

6. The method of claim 4 wherein the look-up directory is contained on a server coupled to the voicemail.

7. The method of claim 4 wherein the look-up directory is contained on the telephone.

8. The method of claim 1 further comprising selecting a message to which to listen based upon the information.

9. The method of claim 2 further comprising returning a phone call based upon the information.

10. The method of claim 9 wherein the phonecall is returned by depressing a single button on the telephone.

11. The method of claim 1 further comprising aggregating messages from the at least two voicemail systems onto one of the at least two voicemail systems.

12. The method of claim 1 wherein messages from the at least two voicemail systems are maintained on their respective voicemail systems.

13. A system for providing visual information to a telephone user regarding voicemail at a telephone number, the system comprising:
a. a telephone network;
b. a telephone comprising a display and in communication with the telephone network;
c. at least two voicemail systems; and
d. a visual voicemail manager configured to organize information relating to messages in the voice mail systems, the information comprising an identifier indicating with which voicemail service each message is associated, and to display the information on the display.

14. The system of claim 13 wherein the information further comprises the number of messages, a primary phone number from which each message was received and a name associated with each primary phone number.

15. The system of claim 14 wherein the information further comprises at least one of at least one alternative phone number associated with each primary phone number and a length of time for each message.

16. The system of claim 14 further comprising a look-up directory on the voicemail system.

17. A system in accordance with claim 14 wherein the at least two voicemail systems each comprise a voicemail server and at least one of the at least two voicemail systems further comprises a gateway in communication with the telephone network and the respective voicemail server.

18. A method of doing business by providing visual information to a telephone user regarding voicemail associated with the telephone user, the method comprising:
a. selling at least telephone service to the telephone user
b. providing a telephone comprising a display;
c. organizing information relating to messages in at least two voicemail services, the information comprising an identifier indicating with which voicemail service each message is associated;
d. displaying the information on the display.

19. The method of claim 18 wherein the information further comprises at least one of the number of messages, a primary phone number from which each message was received and a name associated with each primary phone number.

20. The method of claim 19 wherein the information further comprises at least one of at least one alternative phone number associated with each primary phone number and a length of time for each message.

21. The method of claim 19 wherein at least some of the information is provided by one of caller identification (caller-ID), ANI or voice prompt and complemented from a look-up directory.

22. The method of claim 21 wherein the look-up directory is contained on a voicemail server.

23. The method of claim 21 wherein the look-up directory is contained on a server coupled to the voicemail.

24. The method of claim 21 wherein the look-up directory is contained on the telephone.

25. The method of claim 18 further comprising selecting a message to which to listen based upon the information.

26. The method of claim 19 further comprising returning a phone call based upon the information.

27. The method of claim 26 wherein the phonecall is returned by depressing a single button on the telephone.

28. The method of claim 18 further comprising aggregating messages from the at least two voicemail systems onto one of the at least two voicemail systems.

29. The method of claim 18 wherein messages from the at least two voicemail systems are maintained on their respective voicemail systems.
